(19) United States
(12) Patent Application Publication
(10) Pub. No.: US 2021/0224228 A1
(43) Pub. Date: Jul. 22, 2021

(54) COMPUTER DEVICE AND METHOD FOR FILE CONTROL

(71) Applicant: Shenzhen Jingjiang Yunchuang Technology Co., Ltd., Shenzhen (CN)

(72) Inventors: XUE-QIN ZHANG, Shenzhen (CN); JUKA OH, Shenzhen (CN); SHANG-HUA HAO, Shenzhen (CN); SHAN LI, Shenzhen (CN)

(21) Appl. No.: 16/851,316

(22) Filed: Apr. 17, 2020

(30) Foreign Application Priority Data
Jan. 21, 2020 (CN) 202010069691.6

(51) Int. Cl. G06F 16/16; G10L 15/26; G06F 3/16

(52) U.S. Cl. CPC G06F 16/168; G06F 3/167; G10L 15/26

(57) ABSTRACT

A file control method includes obtaining input commands from a first input device, the first input device includes one of a voice device, a camera, a motion sensor, and a brain machine; determining information on a file to be controlled and file control commands which can be performed by file editing software based on the input commands, the information on the file to be controlled includes a file name, a specific position in the file to be controlled, the file control commands include inserting, deleting, or modifying specific content at the specific position; and controlling the file editing software to perform the file control commands to control the file.

### CROSS-REFERENCE TO RELATED APPLICATIONS

This application claims priority to Chinese Patent Application No. 202010069691.6 filed on Jan. 21, 2020, the contents of which are incorporated by reference herein.

### FIELD

The subject matter herein generally relates to a method, and a computer device for file control.

### BACKGROUND

In general, electronic files need to be controlled during working. Controlling an electronic file can include editing, reviewing, sharing the electronic files. Conventionally, in order to control electronic files, keyboards and/or mouse are used as input devices. However, at some occasions such as conferences, when two or more parties want to control a same electronic file, it may be convenient to use a keyboard or a mouse.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates an embodiment of an application environment architecture diagram of a file control method.

FIG. 2 illustrates an embodiment of a flowchart of the file control method.

FIG. 3 shows an embodiment of a tree structure for parsing voice commands.

FIG. 4 shows one embodiment of a schematic structural diagram of a file control device.

FIG. 5 shows one embodiment of a schematic structural diagram of a computer device.

### DETAILED DESCRIPTION

In order to provide a clear understanding of the objects, features, and advantages of the present disclosure, the same are given with reference to the drawings and specific embodiments. It should be noted that non-conflicting embodiments in the present disclosure and the features in the embodiments may be combined with each other without conflict.

In the following description, numerous specific details are set forth in order to provide a full understanding of the present disclosure. The present disclosure may be practiced otherwise than as described herein. The following specific embodiments are not to limit the scope of the present disclosure.

Unless defined otherwise, all technical and scientific terms herein have the same meaning as used in the field of the art as generally understood. The terms used in the present disclosure are for the purposes of describing particular embodiments and are not intended to limit the present disclosure.

The present disclosure, referencing the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

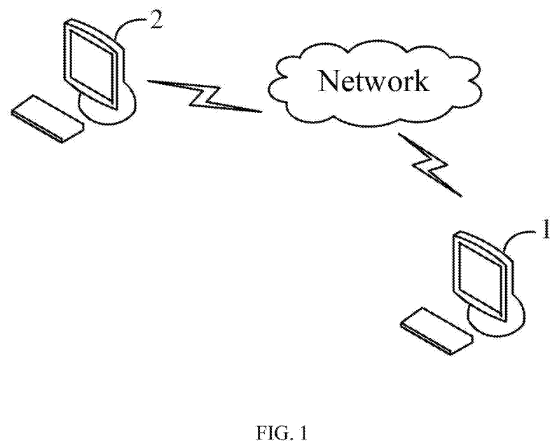

FIG. 1 illustrates an application environment architecture diagram of a file control method. The method is applied in a computer device 1. The computer device 1 is in communication with at least one input device 2. The computer device 1 and the at least one input device 2 can be connected with wires or wireless networks, such as radio wave, Wireless Fidelity (WIFI), cellular networks, satellite networks or broadcast. The computer device 1 is configured to obtain input commands from the input device 2, determine information on electronic files and file control commands based on the input commands, and control corresponding editing software to perform the file control commands. The input device 2 is configured to generate input commands based on user's input. The user's input can include voice, image, movement, or idea. The file control commands can include, but are not limited to, new a file, close a file, editing commands, and reviewing commands. The editing commands can include, but are not limited to, inserting specific content, deleting specific content, and modifying specific content. The specific content can include text, images, or voice. The reviewing commands can include, but are not limited to, back to a previous page, or going to a next page.

The computer device 1 can be any electronic device capable of performing file control, such as a personal computer, a tablet computer, or a server. The computer device 1 includes at least one editing software through which files can be controlled. The server includes, but is not limited to, a single server, a cluster of servers, a cloud server, etc.

The input device 2 can be any electronic device capable of generating input commands based on user's input. The input device 2 can be, but is not limited to, a keyboard, a mouse, a voice input device, a camera, a motion sensor, or a brain machine.

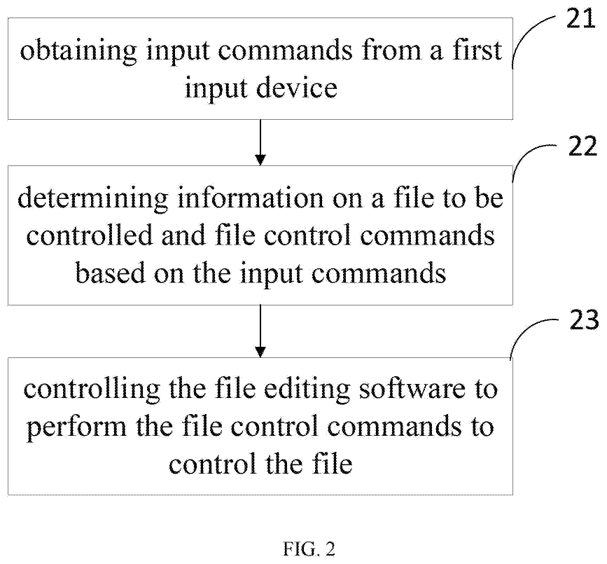

FIG. 2 illustrates an embodiment of a flowchart of the file control method. The file control method is applied to a computer device. For a computer device that needs to perform file control function, the function for file control provided by the method of the present disclosure can be directly integrated on the computer device, or run on the computer device in the form of a software development kit (SDK).

Referring to FIG. 2, the method is provided by way of example, as there are a variety of ways to carry out the method. Each block shown in FIG. 2 represents one or more processes, methods, or subroutines, carried out in the method. Furthermore, the illustrated order of blocks is illustrative only and the order of the blocks can be changed. Additional blocks can be added or fewer blocks can be utilized without departing from this disclosure. The file control method may begin at block 21.

At block 21, the computer device 1 obtains input commands from a first input device 2.

In at least one embodiment, the first input device 2 can be a keyboard, a mouse, a voice input device, a camera, a motion sensor, or a brain machine. The voice input device can include a microphone or a pickup. The camera can be a camera of a mobile phone, an independent camera, a video camera, a monitoring device, or a smart wearable device. The motion sensor can be a sensor having an accelerometer and a gyroscope, including six-axis sensor or a three-axis sensor. The brain machine can be an implantable brain machine or a non-implantable brain machine.

At block 22, the computer device 1 determines information on an electronic file to be controlled, and file control commands which can be performed by corresponding editing software, based on the input commands.

In at least one embodiment, the information on the electronic file can include, but is not limited to, file name, corresponding editing software, and file storage location.

The file control commands can include presenting, deleting, searching, replacing, or inserting specific content of a file. The specific content can include at least one of image, text, and voice.

If the input commands are received from a voice input device, block 22 may include (a). the computer device 1 converts voice commands to text commands using voice recognition technologies.

Conventional voice recognition technology can include Dynamic Time Warping (DTW), Hidden Markov Model (HMM) based on parameters model, and Vector Quantization (VQ) Model based on non-parameter model. Any available voice recognition technology can be used by the computer device 1 to convert the voice commands to the text commands.

(b). the computer device 1 determines the information on the electronic file to be controlled and the file control commands based on the text commands.

In at least one embodiment, the text commands can be parsed into sematic commands. There can be a preset sematic command database which defines a plurality of sematic commands and each of the plurality of sematic commands corresponds to a specific file name and a file control command. The information on the electronic file to be controlled and the file control commands thus can be determined by comparing the sematic commands corresponding to the text commands to the preset sematic command database.

In at least one embodiment, the voice commands can be used to control an electronic device, such as a camera, a voice device (for example, microphone, speaker), a motion sensor, or a brain machine. The voice commands can control turning on/off the electronic device or operation of the electronic device.

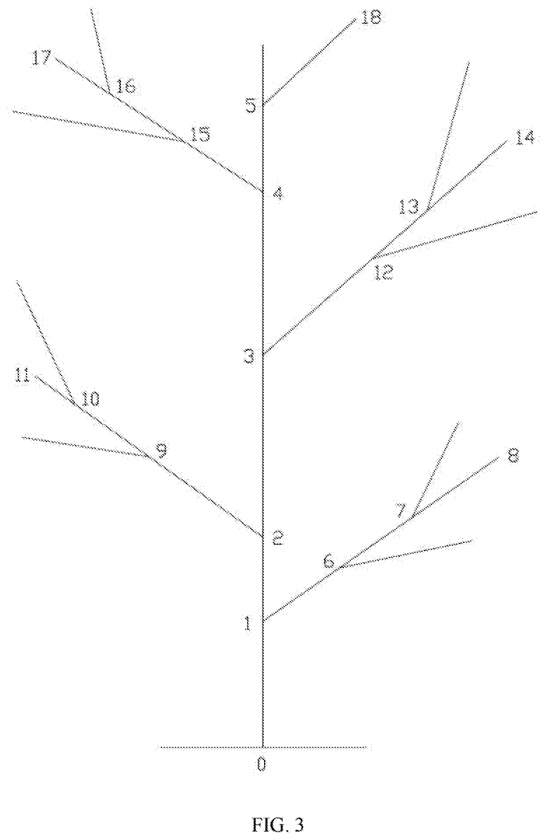

In at least one embodiment, the voice commands can be analyzed using a voice command parsing tree. FIG. 3 shows an embodiment of a voice command parsing tree. The voice command parsing tree includes main nodes 1, 2, 3, 4, 5. Main node 1 is directed to electronic files, main node 2 is directed to cameras, main node 3 is directed to voice devices, main node 4 is directed to motion sensors, and main node 5 is directed to brain machines.

The main node 1 includes a plurality of sub nodes which indicates information on a file to be controlled and operations on the file. In at least one embodiment, sub node 6 is directed to file names, for example, file 1. Sub node 7 is directed to a specific location in the file, for example, page 8 line 11. Sub node 8 is directed to operation to the file, such as inserting, deleting, modifying some content.

In at least one embodiment, when users want to use other input devices, such as a motion sensor, or a brain machine, the users can control the motion sensor or the brain machine to start controlling or to finish controlling a file via the voice commands. In at least one embodiment, the users can control the other input devices in other ways, for example, control buttons on the other input devices.

In at least one embodiment, the voice commands can control a camera to take a picture and insert the picture into a file or control a voice device to create an audio and insert the audio into a file.

If the input commands are received from a motion sensor, the computer device 1 determines the information on the file to be controlled and the file control commands based on motion information.

For example, the motion sensor is a wearable device which is put on a user's wrist. When the user moves his hand, the motion sensor can detect user movements and determine the motion information based on the user movements. The motion information can include moving direction, moving velocity, or moving acceleration. The motion information can be determined using a Roll-pitch-yaw model.

In at least one embodiment, there is a preset relationship between different motion information and the information on the file to be controlled and the file control commands. For example, when the motion information is moving toward left, corresponding file control commands are going to next page; when the motion information is moving downward, corresponding file control commands are closing the file.

If the input commands are received from a camera, the input commands are pictures taken by the camera, block 22 may include

(a). The computer device 1 identifies motion information using human action recognition technology. The human action recognition technology can include, but is not limited to, human action recognition technology based on machinery vision, and human action recognition technology based on deep learning.

In at least one embodiment, identifying the motion information may include identifying key points in the pictures, interconnecting the key points to obtain a plurality of distance vectors, determining the motion information based on the plurality of distance vectors.

For example, the computer device 1 obtains a video from a camera, and separates a plurality of frames depicting human actions. The computer device 1 then identifies a plurality of key points, such as, head portion, shoulder portion, hand portion, and foot portion. The computer device 1 interconnects the plurality of key points to obtain a plurality of distance vectors. The computer device 1 determines motion information based on the plurality of distance vectors. The motion information includes, but is not limited to, gestures, head movements, and body movements.

(b). The computer device 1 determines the information on the file to be controlled and the file control commands based on the motion information.

At block 23, the computer device 1 controls corresponding file editing software to perform the file control commands.

For example, the file control commands can be deleting a sentence located at page 25 line 10. The file editing software positions the cursor to page 25 line 10, and then removes the sentence from the file.

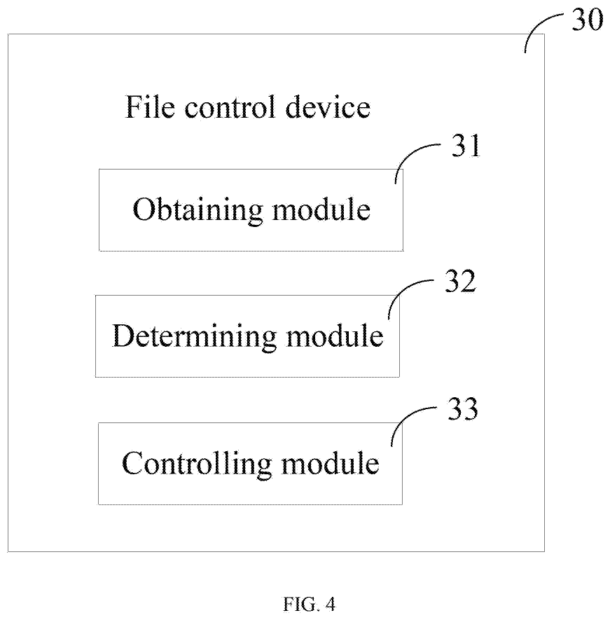

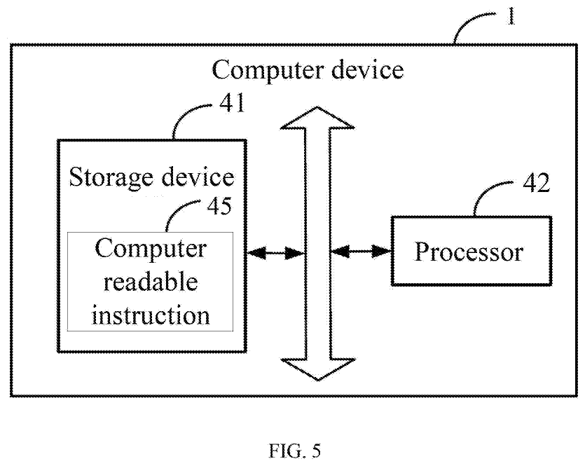

FIG. 2 shows an embodiment of the file control method, the following is an introduction to the functional modules that implement the file control method and the hardware device architecture that implements the file control method in combination with FIGS. 4-5.

FIG. 4 shows an embodiment of modules of a file control device 30.

In at least one embodiment, the file control device 30 can apply in a computer device. The file control device 30 can include a plurality of functional modules consisting of program code segments. The program code of each program segment in the file control device 30 may be stored in a storage device of a server and executed by at least one processor to perform the file control method (described in detail in FIG. 2).

In at least one embodiment, the file control device 30 can include a plurality of modules. The plurality of modules can include, but is not limited to, an obtaining module 31, a determining module 32, and a controlling module 33. The modules 31-33 can include computerized instructions in the form of one or more computer-readable programs that can be stored in the non-transitory computer-readable medium (e.g., the storage device of the computer device), and executed by the at least one processor of the computer device to implement the file control method (e.g., described in detail in FIG. 2).

The obtaining module 31 is configured to obtain input commands from a first input device 2.

In at least one embodiment, the first input device 2 can be a keyboard, a mouse, a voice input device, a camera, a motion sensor, or a brain machine. The voice input device can include a microphone or a pickup. The camera can be a camera of a mobile phone, an independent camera, a video camera, a monitoring device, or a smart wearable device. The motion sensor can be a sensor having an accelerometer and a gyroscope, including six-axis sensor or a three-axis sensor. The brain machine can be an implantable brain machine or a non-implantable brain machine.

The determining module 32 is configured to determine information on an electronic file to be controlled, and file control commands which can be performed by corresponding editing software, based on the input commands.

In at least one embodiment, the information on the electronic file can include, but is not limited to, file name, corresponding editing software, and file storage location.

The file control commands can include presenting, deleting, searching, replacing, or inserting specific content of a file. The specific content can include at least one of image, text, and voice.

If the input commands are received from a voice input device, the determining module 32 is configured to (a). convert voice commands to text commands using voice recognition technologies.

Conventional voice recognition technology can include Dynamic Time Warping (DTW), Hidden Markov Model (HMM) based on parameters model, and Vector Quantization (VQ) Model based on non-parameter model. Any available voice recognition technology can be used by the determining module 32 to convert the voice commands to the text commands.

(b). determine the information on the electronic file to be controlled and the file control commands based on the text commands.

In at least one embodiment, the text commands can be parsed into sematic commands. There can be a preset sematic command database which defines a plurality of sematic commands and each of the plurality of sematic commands corresponds to a specific file name and a file control command. The information on the electronic file to be controlled and the file control commands thus can be determined by comparing the sematic commands corresponding to the text commands to the preset sematic command database.

In at least one embodiment, the voice commands can be used to control a second input device, such as a camera, a voice device (for example, microphone, speaker), a motion sensor, or a brain machine. The voice commands can control turning on/off the second input device or operation of the second input device so as to allow a user to control the file with the second input device. For example, when a plurality of parties cooperating with a same file, a first one of the plurality of parties control the file with a first input device such as a keyboard or a mouse, a second one of the plurality of parties control a second input device such as a motion sensor to turned on with voice commands and using the second input device to control the file. Therefore, the plurality of parties can use different input devices to control a same file.

In at least one embodiment, the voice commands can be analyzed using a voice command parsing tree. FIG. 3 shows an embodiment of a voice command parsing tree. The voice command parsing tree includes main nodes 1, 2, 3, 4, 5. Main node 1 is directed to electronic files, main node 2 is directed to cameras, main node 3 is directed to voice devices, main node 4 is directed to motion sensors, and main node 5 is directed to brain machines. The main node 1 includes a plurality of sub nodes which indicates information on a file to be controlled and operations on the file. In at least one embodiment, sub node 6 is directed to file names, for example, file 1. Sub node 7 is directed to a specific location in the file, for example, page 8 line 11. Sub node 8 is directed to operation to the file, such as inserting, deleting, modifying some content.

In at least one embodiment, when users want to use other input devices, such as a motion sensor, or a brain machine, the users can control the motion sensor or the brain machine to start controlling or to finish controlling a file via the voice commands. In at least one embodiment, the users can control the other input devices in other ways, for example, control buttons on the other input devices.

In at least one embodiment, the voice commands can control a camera to take a picture and insert the picture into a file or control a voice device to create an audio and insert the audio into a file.

If the input commands are received from a motion sensor, the determining module 32 can be configured to

(a). identify motion information from the motion sensor.

For example, the motion sensor is a wearable device which is put on a user's wrist. When the user moves his hand, the motion sensor can detect user movements and determine the motion information based on the user movements. The motion information can include moving direction, moving velocity, or moving acceleration. The motion information can be determined using a Roll-pitch-yaw model.

(b). determine the information on the file to be controlled and the file control commands based on the motion information. In at least one embodiment, there is a preset relationship between different motion information and the information on the file to be controlled and the file control commands. For example, when the motion information is moving toward left, corresponding file control commands are going to next page; when the motion information is moving downward, corresponding file control commands are closing the file.

If the input commands are received from a camera, the input commands are pictures taken by the camera, the determining module 32 can be configured to

(a). identify motion information using human action recognition technology. The human action recognition technology can include, but is not limited to, human action recognition technology based on machinery vision, and human action recognition technology based on deep learning.

In at least one embodiment, identifying the motion information can include identifying key points in the pictures, interconnecting the key points to obtain a plurality of distance vectors, determining the motion information based on the plurality of distance vectors.

For example, the determining module 32 obtains a video from a camera, and separates a plurality of frames depicting human actions. The determining module 32 then identifies a plurality of key points, such as, head portion, shoulder portion, hand portion, and foot portion. The determining module 32 interconnects the plurality of key points to obtain a plurality of distance vectors. The determining module 32 determines motion information based on the plurality of distance vectors. The motion information includes, but is not limited to, gestures, head movements, and body movements.

(b). determine the information on the file to be controlled and the file control commands based on the motion information.

The controlling module 33 is configured to control corresponding file editing software to perform the file control commands.

For example, the file control commands can be deleting a sentence located at page 25 line 10. The file editing software positions the cursor to page 25 line 10, and then removes the sentence from the file.

FIG. 5 shows one embodiment of a schematic structural diagram of the computer device 1. In an embodiment, the computer device 1 includes a storage device 41 and at least one processor 42. The computer device 1 can further include at least one computer readable instruction 45, stored in the storage device 41, and executable on the at least one processor 42. When the processor 42 executes the computer readable instruction 45, the file control method is implemented, for example, blocks 21-23 shown in FIG. 2.

In at least one embodiment, the at least one computer readable instruction 45 can be partitioned into one or more modules/units that are stored in the storage device 41 and executed by the at least one processor 42. The one or more modules/units may be a series of computer program instruction segments capable of performing a particular function for describing the execution of the computer readable instruction 45 in the computer device 1.

In at least one embodiment, the computer device 1 is a device, the hardware thereof includes, but is not limited to, a microprocessor and an application specific integrated circuit (ASIC), Field-Programmable Gate Array (FPGA), Digital Signal Processor (DSP), embedded devices, etc. It can be understood by those skilled in the art that the schematic diagram is merely an example of the computer device 1, it does not constitute a limitation of the computer device 1, other examples may include more or less components than those illustrated, or combine some components, or different components. For example, the computer device 1 may further include an input/output device, a network access device, a bus, and the like.

In some embodiments, the at least one processor 42 may be a central processing unit (CPU), and may also include other general-purpose processors, digital signal processors (DSPs), application specific integrated circuits (ASICs), and off-the-shelf programmable gate arrays, Field-Programmable Gate Array (FPGA), or other programmable logic device, discrete gate, or transistor logic device, discrete hardware components, etc. The general-purpose processor may be a microprocessor or the processor may be any conventional processor or the like. The processor 42 is a control center of the computer device 1, and connects sections of the entire computer device 1 with various interfaces and lines.

In some embodiments, the storage device 41 can be used to store program codes of computer readable programs and various data, such as the file control device 30 installed in the computer device 1. The storage device 41 can include a read-only memory (ROM), a random access memory (RAM), a programmable read-only memory (PROM), an erasable programmable read only memory (EPROM), a one-time programmable read-only memory (OTPROM), an electronically-erasable programmable read-only memory (EEPROM)), a compact disc read-only memory (CD-ROM), or other optical disk storage, magnetic disk storage, magnetic tape storage, or any other storage medium readable by the computer device 1.

The modules/units integrated by the computer device 1 can be stored in a computer readable storage medium if implemented in the form of a software functional unit and sold or used as a stand-alone product. The present disclosure implements all or part of the processes in the foregoing embodiments, and a computer program may also instruct related hardware. The computer program may be stored in a computer readable storage medium. The steps of the various method embodiments described above may be implemented by a computer program when executed by a processor. Wherein, the computer program comprises computer program code, which may be in the form of source code, product code form, executable file, or some intermediate form. The computer readable medium may include any entity or device capable of carrying the computer program code, a recording medium, a USB flash drive, a removable hard disk, a magnetic disk, an optical disk, a computer memory, a read-only memory (ROM), random access memory (RAM), electrical carrier signals, telecommunications signals, and software distribution media. It should be noted that the content contained in the computer readable medium may be increased or decreased according to the requirements of legislation and patent practice in a jurisdiction, for example, in some jurisdictions, computer-readable media does not include electrical carrier signals and telecommunication signals.

The above description only describes embodiments of the present disclosure, and is not intended to limit the present disclosure, various modifications and changes can be made to the present disclosure. Any modifications, equivalent substitutions, improvements, etc. made within the spirit and scope of the present disclosure are intended to be included within the scope of the present disclosure.

What is claimed is:

1. A file control method, comprising:
obtaining input commands from a first input device, the first input device including one of a voice device, a camera, a motion sensor, and a brain machine;
determining information on a file to be controlled and file control commands which can be performed by file editing software based on the input commands, wherein the information on the file to be controlled includes a file name, a specific position in the file to be controlled, the file control commands include inserting, deleting, or modifying specific content at the specific position; and
controlling the file editing software to perform the file control commands to control the file.

2. The method according to claim 1, wherein the first input device is the voice device and the input commands are voice commands, said determining the information on the file to be controlled and the file control commands comprises:
converting the voice commands to text commands using voice recognition technologies; and
determining the information on the file to be controlled and the file control commands based on the text commands by comparing the text commands with a preset text command database, wherein the preset text command database defines relationship among the text commands and the information on the file, the file control commands.

3. The method according to claim 2, wherein the voice commands are configured to control a second input device, said determining the information on the file to be controlled and the file control commands based on the text commands is performed based on a voice command parsing tree,
wherein the voice command parsing tree includes a plurality of main nodes, one of the plurality of main nodes is directed to files to be controlled, one of the plurality of main nodes is directed to the second input device.

4. The method according to claim 3, wherein the one of the plurality of main nodes directed to the second input device includes a plurality of sub nodes, each of the plurality of sub nodes is directed to a function of the second input device.

5. The method according to claim 4, wherein the second input device is a camera, the function of the second input device includes taking a specific picture; or the second input device is a voice camera, the function of the second input device includes creating a specific audio.

6. The method according to claim 1, wherein the specific content is text or a picture taken by a camera or an audio obtained from the voice device.

7. The method according to claim 6, wherein the first input device is the motion sensor, and the input commands are motion information, the motion information includes moving direction, moving velocity, or moving acceleration.

8. The method according to claim 6, wherein the first input device is the camera and the input commands are pictures taken by the camera, said determining the information on the file to be controlled and the file control commands comprises:
identifying motion information using human action recognition technology; and
determining the information on the file to be controlled and the file control commands based on the motion information.

9. The method according to claim 8, wherein said identifying the motion information using the human action recognition technology comprises:
identifying key points in the pictures;
interconnecting the key points to obtain a plurality of distance vectors; and
determining the motion information based on the plurality of distance vectors.

10. A computer device, comprising:
a storage device;
at least one processor; and
the storage device storing one or more programs, which when executed by the at least one processor, cause the at least one processor to:
obtain input commands from a first input device, the first input device including one of a voice device, a camera, a motion sensor, and a brain machine;
determine information on a file to be controlled and file control commands which can be performed by file editing software based on the input commands, wherein the information on the file to be controlled includes a file name, a specific position in the file to be controlled, the file control commands include inserting, deleting, or modifying specific content at the specific position; and
control the file editing software to perform the file control commands to control the file.

11. The computer according to claim 10, wherein the first input device is the voice device and the input commands are voice commands, the at least one processor is caused to:
convert the voice commands to text commands using voice recognition technologies; and
determine the information on the file to be controlled and the file control commands based on the text commands by comparing the text commands with a preset text command database, wherein the preset text command database defines relationship among the text commands and the information on the file, the file control commands.

12. The computer according to claim 11, wherein the voice commands are configured to control a second input device, the at least one processor is caused to determine the information on the file to be controlled and the file control commands based on the text commands using a voice command parsing tree,
wherein the voice command parsing tree includes a plurality of main nodes, one of the plurality of main nodes is directed to files to be controlled, one of the plurality of main nodes is directed to the second input device.

13. The computer according to claim 12, wherein the one of the plurality of main nodes directed to the second input device includes a plurality of sub nodes, each of the plurality of sub nodes is directed to a function of the second input device.

14. The computer according to claim 13, wherein the second input device is a camera, the function of the second input device includes taking a specific picture; or the second input device is a voice device, the function of the second input device includes creating a specific audio.

15. The computer according to claim 10, wherein the specific content is text or a picture taken by a camera or an audio obtained from the voice device.

16. The computer according to claim 15, wherein the first input device is the motion sensor, and the input commands are motion information, the motion information includes moving direction, moving velocity, or moving acceleration.

17. The computer according to claim 15, wherein the first input device is the camera and the input commands are pictures taken by the camera, the at least one processor is caused to:
identify motion information using human action recognition technology; and
determine the information on the file to be controlled and the file control commands based on the motion information.

18. The computer according to claim 17, wherein the at least one processor is caused to:
identify key points in the pictures;
interconnect the key points to obtain a plurality of distance vectors; and
determine the motion information based on the plurality of distance vectors.

19. A non-transitory storage medium having stored thereon instructions that, when executed by a processor of a computer device, causes the processor to perform a file control method, the method comprising:
obtaining input commands from a first input device, the first input device including one of a voice device, a camera, a motion sensor, and a brain machine;
determining information on a file to be controlled and file control commands which can be performed by file editing software based on the input commands, wherein the information on the file to be controlled includes a file name, a specific position in the file to be controlled, the file control commands include inserting, deleting, or modifying specific content at the specific position; and
controlling the file editing software to perform the file control commands to control the file.

20. The non-transitory storage medium according to claim 19, wherein the specific content is text or a picture taken by a camera or an audio obtained from the voice device.
